(19) United States
(12) Patent Application Publication
(10) Pub. No.: US 2018/0356288 A1
(43) Pub. Date: Dec. 13, 2018

(54) INSPECTION SYSTEM FOR ESTIMATING WALL FRICTION IN COMBUSTION ENGINES

(71) Applicant: Industrial Optical Measurement Systems, Ann Arbor, MI (US)

(72) Inventor: Stephen Barrett Segall, Ann Arbor, MI (US)

(21) Appl. No.: 16/005,046

(22) Filed: Jun. 11, 2018

Related U.S. Application Data
(60) Provisional application No. 62/518,214, filed on Jun. 12, 2017.

(51) Int. Cl. G01J 5/00; G01J 5/08; G01N 21/55

(52) U.S. Cl. CPC G01J 5/0066; G01N 21/55; G01J 5/0862; G01J 5/0896

(57) ABSTRACT

A non-contact optical probe for inspecting the surface of a workpiece includes: a laser source that emits an incident beam of light, an optical system that focuses the optical beam and directs the focused incident beam onto the surface being inspected, a mechanism for scanning the focused beam across the surface being inspected by moving the focal point of the beam relative to the surface, an encoder system that tracks the location of the focused beam on the surface as a function of position, and a wavelength filter that prevents scattered and reflected laser radiation and ambient visible light from reaching an infrared detector inside the probe. The probe design also prevents infrared radiation from locations other than the spot illuminated by the focused laser beam from reaching the detector.

### CROSS-REFERENCE TO RELATED APPLICATIONS

This application claims priority to U.S. Application Ser. No. 62/518,214 filed on Jun. 15, 2017. The entire disclosure of the above application is hereby incorporated by reference.

### FIELD

This disclosure is directed to the inspection of machined cylinder walls, primarily used in internal combustion engines, for features that generate friction and waste energy when the engine is operating. This disclosure is also directed to the inspection of other cylindrically symmetric objects with machined surfaces containing moving parts in which friction reduction is a priority.

### BACKGROUND

Internal combustion engines transmit power to a drive train by means of pistons that move back and forth in their cylinders as a result of the combustion of fuel in the region above the deck of each cylinder. Surface roughness on the cylinder wall can result in frictional heating of the wall and a reduction in engine efficiency. Therefore, manufacturers of internal combustion engines are interested in techniques to measure and reduce the causes of friction in their engines.

One characteristic of cylinder walls that correlates with loss of energy due to friction during engine operation is surface roughness. Surface roughness refers to variations in the smoothness of a surface on a microscopic scale that can produce heat when two surfaces slide against each other. Surface roughness in combustion cylinders typically occurs on a micrometer scale and can be produced by the tools and machining operations that shape the cylinder wall. Surface roughness will be increased when a cutting tool generates sharp microscopic peaks on the cylinder surface, referred to as asperities, or the machining operation generates torn and folded metal on a microscopic scale as a result of the cutting operation.

While reduced surface roughness is desired to reduce friction, cylinder walls are not perfectly smooth. A pattern of honing marks is needed on the cylinder wall to retain a film of lubricant on the wall. Without this pattern of honing marks the lubricant could slip off the wall due to gravity. This could result in metal to metal contact between the cylinder wall and the piston ring that would destroy the cylinder. A lubricating film is also maintained in a combustion cylinder to prevent blowby of hot gases between the cylinder wall and the top piston ring. However, creation of the pattern of machining marks produces the microscopic metal peaks and specks that contribute to the generation of friction.

To prevent the creation of large pores that could affect the retention of oil, a new technique to spray liquid metal onto the cylinder surface and then polish down the honing marks to expose microscopic oil-retaining pores is being developed. This technique has its own set of problems, however. The deposition of the metal spray can result in the creation of peaks and craters in the deposited spray if the deposition is nonuniform. Excess polishing of the area of traversal of the top piston ring could also reduce the size of the exposed pores. The oil trapped in very small pores may not be wiped away by the top piston ring and may be burned off by subsequent expansion of hot gasses in the cylinder. This could cause the cylinder to burn more oil than is acceptable. This is not, however, a surface roughness problem. Increased surface roughness will be found primarily at the bottom of the cylinder, past the region traversed by the top piston ring.

Surface roughness can be measured using a contact gauge, such as a stylus. The stylus typically has a diamond tip about 2 μm in diameter that is dragged across the surface of the part being measured. The variation in height of the tip is recorded as a function of position along the surface. The diamond tip is delicate and can be snapped off if variation in surface height is too steep. The stylus only measures surface roughness over a line about 1 centimeter long and usually only samples an infinitesimally small fraction of the surface area. Often samples are taken at various positions in a cylinder since surface roughness can vary as a function of position.

Other techniques have been used to measure surface roughness, such as optical images viewed under a microscope. The focal point of a microscope can be varied to focus at different depths to obtain a 3D image of the surface. Other instruments that could be used to measure minute surface roughness features include scanning electron microscopes and atomic force microscopes. High resolution inspection systems are slow, expensive, require a high-level of operator expertise and only inspect a statistical sample of parts on a production line as well as only a small fraction of the surface of the parts being inspected.

Measurements of different types of surface roughness may be needed to determine the frictional energy losses that can be expected due to surface roughness. The values for surface roughness are usually designated with the letter R and various subscripts, such as Ra and Rz for linear values of surface roughness and Sₚₖ, Sₖ, and Sᵥₖ for surface area values. Several types of surface roughness measurements may be needed to collect the relevant data to calculate the friction-generating capacity of the surface at a given location.

Probes have been developed for scanning the surface of a cylinder with a focused laser beam and detecting reflected or scattered laser light from the cylinder surface. These measurements can detect defects such as pores or scratches in the cylinder surface but cannot adequately detect small scale surface roughness. It is likely that a manufacturer of combustion engines would first want to inspect the cylinder walls of an engine block using the collection of scattered laser light for detection of relatively large defects, which could cause a block to be rejected as defective, before performing an inspection to detect micrometer scale features that could generate unwanted friction.

Techniques for the measurement of surface and subsurface defects have been developed that use infrared cameras for inspecting surfaces that have been rapidly heated with a pulse of energy to look for hot spots as the surfaces cool. They are usually employed for inspecting non-metallic surfaces, such as carbon fiber composites, to identify subsurface regions with structural defects. Metallic surfaces generally are not considered appropriate for this technique because they rapidly conduct heat pulses away and do not show surface or subsurface structure in the infrared portion of the spectrum. The technique for obtaining information about component defects from infrared imaging is sometimes referred to as infrared flash thermography.

Such techniques utilize a significant amount of energy to heat a part. This energy can be supplied by a flash lamp similar to those used to excite lasing material in a high power solid state laser. The heated surface is viewed using a digital infrared camera and the variation over time of the infrared image is recorded. Different depths may dominate the heat radiated at different times as the surface of the object cools.

Similar techniques have been used for determining the thickness of metal foils and for determining the depth of cracks in a surface.

### SUMMARY

This disclosure relates to an instrument and method for the rapid inspection of cylindrical surfaces for the detection of microscopic friction-generating metal particles that are now detected by direct measurement of surface roughness. The method and instrument described in this disclosure permit the amount of friction-causing roughness on a surface to be determined orders of magnitude more rapidly than direct measurements of surface roughness by rapidly heating tiny bits and peaks of metal with a focused scanning laser beam and recording the locations on the surface where temperature variations occur using an infrared detector. The technique can permit the entire surface of a cylinder to be rapidly scanned so that every part of the surface, not just a statistical sample, can be measured for the existence of friction-causing roughness. These measurements can be compared and correlated with direct surface roughness measurements to calibrate the infrared measurements against conventional surface roughness measurements.

According to one aspect of the present disclosure, a non-contact optical probe for inspecting the surface of a workpiece includes: a laser source that emits an incident beam of light, an optical system that focuses the optical beam and directs the focused incident beam onto the surface being inspected, a mechanism for scanning the focused beam across the surface being inspected by moving the focal point of the beam relative to the surface, an encoder system that tracks the location of the focused beam on the surface as a function of position, and a wavelength filter that prevents scattered and reflected laser radiation and ambient visible light from reaching an infrared detector inside the probe. The probe prevents infrared radiation from locations other than the spot illuminated by the focused laser beam from reaching the detector.

In an additional aspect of the present disclosure, the laser beam is incident perpendicular to the surface of the workpiece and the infrared radiation from the focused spot is detected at an angle relative to the workpiece surface, the aperture permitting radiation to enter the probe to block infrared radiation not coming directly from the location of the focused laser spot during the scan.

In another aspect of the present disclosure, the infrared radiation entering the probe through the wavelength filter is reflected from a mirror inside the probe with a coating designed to maximize IR reflectivity, the mirror between the wavelength filter and the detector being aligned so that the center of the transmitted beam is reflected parallel to the probe axis.

In another aspect of the present disclosure, the mechanism for scanning the laser beam across the surface being inspected is a spindle together with a linear motion stage moving the scanning beam axially across the surface.

In another aspect of the present disclosure, the infrared detector detects rapid variations in infrared radiation from the surface being inspected as it is scanned by the incident laser beam.

In another aspect of the present disclosure, the detector signal is processed by a preamplifier circuit integrated into the detector.

In another aspect of the present disclosure, the detector cavity is artificially cooled to maximize the sensitivity of the detector to IR radiation.

In another aspect of the present disclosure, a thermoelectric cooling unit cools the detector.

In another aspect of the present disclosure, a mechanism for keeping the detector cool is a flow of cold dry gas such as nitrogen.

In another aspect of the present disclosure, the surface being inspected is the surface of a cylinder.

In another aspect of the present disclosure, the probe includes a data acquisition system that records the infrared radiation signal as a function of position on the surface of the workpiece as the workpiece is being scanned.

In another aspect of the present disclosure, the probe includes a processing unit implemented with an algorithm that maps the variation in infrared radiation as a function of position on the surface of the workpiece to identify changes in the amount of infrared radiation emitted by the surface as the scanning laser beam passes over it.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 shows a spectral response for a Hamamatsu IR detector;

FIG. 2 is a schematic drawing of an inspection system in an operating environment in accordance with the principles of the present disclosure; and

FIG. 3 is a cross sectional view of an exemplary surface roughness probe in accordance with the principles of the present disclosure.

### DETAILED DESCRIPTION

Current laser-scanning inspection probes do not measure the amount of laser light absorbed by the surface being inspected. However, if the detector sensing the laser light returned from the cylinder surface is replaced by a fast-time-response infrared detector that can detect small changes in surface temperature, and laser and visible light is prevented from reaching this detector using filters that block visible light but transmit infrared light, then the detectors could record the locations on the surface that are being locally heated as the focused laser beam passes over them. Such filters are available commercially. Notch and dichroic filters reject light at the laser wavelength, but pass light at other wavelengths, and lowpass filters transmit light at wavelengths above a specified value.

The present disclosure is different from previous flash thermography arrangements in which an entire surface area is heated simultaneously by a high-power heating source such as a flash lamp and then monitored as it gradually cools down. A fast infrared detector, such as an infrared photodiode or photoconductive detector, is needed to record the brief temperature rise caused by the focused laser spot as it scans the cylinder surface, but an infrared camera is usually not employed for this arrangement. Both the laser beam and detector signals are analog to correctly determine the locations of the features and the amount of heating.

The inspection system of this disclosure functions by scanning the surface of a cylinder with a focused laser beam and detecting the variation in infrared radiation produced by the area illuminated by the focused spot as the spot it scans over the surface. The output of the infrared detector in the laser scanning probe is digitized and collected into a data file that can be used to display an image of the surface which is related to the infrared light output of the surface when the surface is scanned. The regions of detectable infrared radiation variation in this surface image indicate the locations of small metal particles that could cause frictional losses when they interact with a moving metallic surface, such as a piston ring.

In general, the mass of a combustion cylinder is so large and the conductivity of the metal wall so high that no detectible rise in temperature will be produced in the bulk surface material of the cylinder wall as a scanning laser beam passes over the surface. However, if a microscopic piece of metal is protruding or dangling from the surface it can be instantaneously heated as the laser beam scans the surface and the brief variation in temperature can be detected by a high-speed infrared detector. In this way, a map of hot spots on the surface of the cylinder can be produced, which can be correlated with the measured amount of surface roughness obtained by other, slower measurement techniques.

Recently a variety of infrared (IR) detectors has become commercially available. In particular, Hamamatsu has a large selection, but the choice of components for this disclosure is not limited to products from any one company. New highly transparent materials in the infrared are continuously being developed, primarily for development of new IR lasers (See “New materials extend laser spectral coverage deep into the infrared” Laser Focus World Magazine, April 2018 p. 37). The crystals that are being developed could be used for infrared optics as well as infrared lasers. Custom components may be needed to optimally interface with the rest of a laser scanning probe. One of the properties needed in an infrared detector is a fast time response, since it must detect a short pulse of infrared radiation from an asperity as a focused laser beam passes over it. The time response that is desirable for a detector is about 1 microsecond or less. This time response can usually be achieved with an infrared photodiode matched with a high-speed amplifier circuit.

Different photosensitive materials used in the manufacture of infrared photodiodes are sensitive to different wavelength ranges of radiation. We are interested in choosing a material that produces the largest signal relative to the background for the size features we desire to observe. Some typical photodiodes that are now on the market for detection of infrared radiation include:

InGaAs photodiodes, which are sensitive in the wavelength range from 0.9 to about 2.0 μm;

InAs photodiodes, which can detect IR radiation at wavelengths up to 3.5 μm;

InAsSb photodiodes that can deliver high sensitivity in the 5, 8 and 10 μm ranges. A particular detector can be manufactured with high sensitivity at one or more wavelength ranges;

InSb detectors can detect radiation up to about 6 μm with high sensitivity and high speed. These detectors are designed to deliver high sensitivity in a transmitting atmospheric window between 3 and 5 μm;

Further areas of applicability will become apparent from the description provided herein. It should be understood that the description and specific examples are intended for purposes of illustration only and are not intended to limit the scope of the present disclosure.

Two-color detectors use a combination of two different photosensors, in which one sensor is mounted over the other sensor along the same optical axis. They provide a broad spectral response range covered by the two photosensors. The ratio between the two wavelength signals could provide information about the relative amount that an asperity in a particular location can be heated relative to the cylinder background.

High speed IR photodiodes can also come with integrated preamplifier circuits and thermoelectric cooling units. Since the probe will be detecting radiation with wavelengths above visible wavelengths, scattered laser light and background ambient light must be prevented from reaching the detector. Since optical filters also absorb some IR light, it may be desirable that there be as few transmitting optical components between the wavelength filter and the detector as practical.

Because the laser spot can be very small 100 μm in diameter) and the asperity may be smaller than the laser spot, the location of a friction-causing asperity can be identified even without the use of imaging optics. Having only the wavelength filter between the scattering surface and the detector surface may result in a smaller loss of IR radiation. One material that blocks visible radiation but transmits infrared radiation is silicon. This may not be the only filter material or filtering technique for maximizing the detection of IR radiation by the probe detector that could be used for the arrangements described in this disclosure.

The larger the diameter of the detector sensitive area the larger the solid angle of IR light that could be collected. However, detectors with larger sensitive areas may have slower response times, which could limit the size of the sensitive area of the detector that can be used. Typically, IR-sensitive-detector diameters vary between 1 and 5 mm.

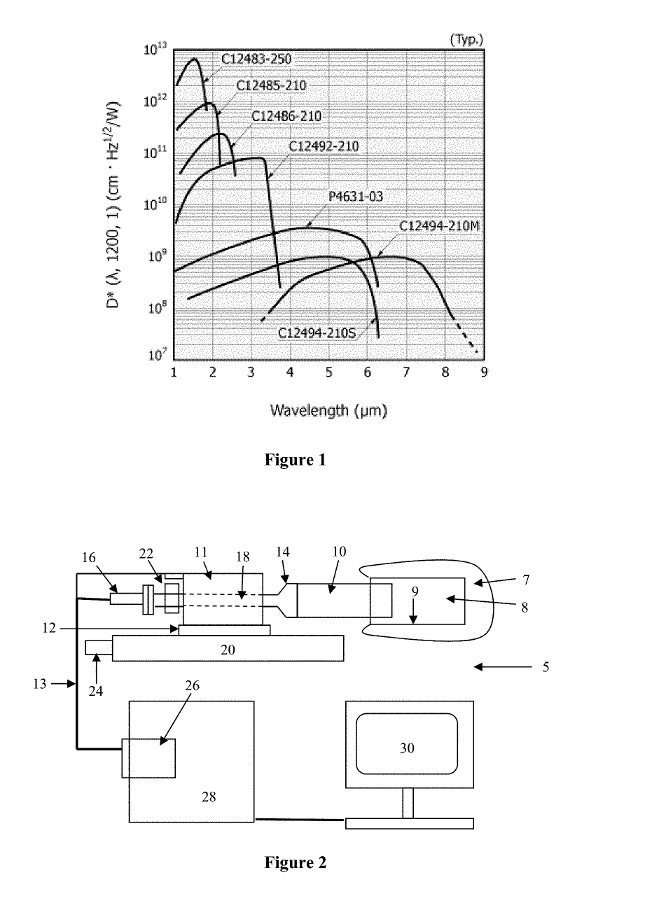

The spectral response for a number of Hamamatsu IR detectors is shown in FIG. 1. It appears that IR wavelengths close to visible wavelengths can be orders of magnitude more sensitive to photodiode detectors than longer wavelength light. It may be desirable to test a number of filter-detector combinations to determine which combination of wavelength and detector sensitivity is most sensitive to IR light generated by the interaction of a scanning laser beam with the sized microscopic metal features one wishes to detect.

It should be noted that the parameter sensitivity ranges presented here do not represent a fundamental limitation on the operation of this device, since improved components with higher resolution are continuously being developed and could replace existing components when they become available.

It should be noted that larger pieces of metal sticking up from the surface, such as specks of torn and folded metal will have a lower intensity signal over a larger area than the smaller asperities, because they have a larger mass. Such specks may have dimensions of 10-20 μm across. It may be possible to identify these larger features because their signal covers a larger area as well as having a lower intensity. However, if the focused laser spot is larger than the feature being scanned, the larger area of the speck would result in more energy being absorbed than for a smaller speck, lessening the effect of the mass difference. It is possible that some of these larger features could also be identified using a traditional scattering probe with an imaging lens, which could be compared with a signal from the IR detector.

Keeping the surface of the detector at a constant low temperature relative to the background temperature on the cylinder surface can also increase the sensitivity of the detector to IR radiation. This cooling can be implemented using thermoelectric cooling circuits or by flowing cold dry nitrogen gas through the detector cavity. Thermoelectric cooling may be preferable, because it is easier to install, maintain and diagnose.

It is clear from the above discussion that there is a range of orders of magnitude in the parameter space over which IR signals can be detected using the principles of this disclosure. This includes variations in focal spot size, revolutions per minute of the spindle, dimensions of the cylinder, sensitivity of the detector material to IR wavelength, laser power and the speed, amplification and saturation values of the electronics. For practical applications we would like to limit the parameter range over which the scanning probe is operated to the range that emphasizes the surface features of interest.

One way to determine the appropriate operating range for a particular application is to identify test surfaces that contain features in the size and shape range of interest. This may be done using instruments that are much slower but have higher resolution than the IR scanning probe. High resolution optical microscopes or scanning electron microscopes may be able to identify such features. Given an appropriate test surface, the probe can be tested over a range of probe parameters to narrow down the range that is appropriate for detection of these features.

With reference to FIG. 2, a schematic diagram of inspection system 5 for inspecting workpiece 7 is shown. Inspection system 5 includes a probe 10, probe shaft 14, spindle 11 with rotatable shaft 18, rotary encoder 22 that rotates below a magnetic reading head of the encoder, slip ring 16, linear positioning machine 20, linear positioning machine platform 12 for mounting spindle 11, linear encoder 24, connecting cables 13, data acquisition unit 26, computer 28, and monitor 30. Not shown are the controller units for the linear positioning machine 20 and rotary spindle 11 that are operated by software in computer 28 or by a separate programmable logic controller.

Workpiece 7 includes an inner cylindrical surface 9 that defines at least one bore 8. In the example provided, bore 8 is a combustion cylinder and workpiece 7 is the block of an internal combustion engine. However, it should be appreciated that cylindrical bore 8 could exist in many other types of workpieces 7, such as, but not limited to, brake cylinders, hydraulic or pneumatic cylinders, or other cylindrical manufactured parts.

Probe 10 is disposed in bore 8. Probe 10 is generally a laser probe, as will be described below. Probe 10 is attached to and centered on probe shaft 14, which has a clear-through hole through the center of the shaft.

In the example provided, probe shaft 14, rotary encoder 22 and slip ring 16 are mounted on spindle rotor shaft 18. Slip ring 16 is electrically connected to the components of probe 10, as will be described in detail below.

Probe shaft 14 is mounted to rotatable shaft 18 of spindle 11. Spindle 11 rotates rotatable shaft 18. Rotatable shaft 18 is a hollow tube. In the example provided, linear positioning machine 20 is a linear motion stage. Spindle 11 and linear positioning machine 20 together constitute a computer numerically controlled (CNC) machine. Probe shaft 14 is mounted in a chuck or collet (not shown) which is mounted on rotatable shaft 18. However, it should be appreciated that other rotating machines 11 capable of rotating probe 10 may be used without departing from the scope of the present disclosure. Standard machining techniques may be used to align the central axis of probe 10 with the axis of rotatable shaft 18. Rotary encoder 22 and linear encoder 24 indicate the angular orientation and the axial position of rotatable shaft 18 in the inspection machine system.

Data acquisition unit 26 may be an internal data acquisition card installed in computer 28 or an external data collection unit in communication with computer 28. However, other types of devices that perform the same functions as computer 28 may be employed without departing from the scope of the present disclosure. Data acquisition unit 26 is in communication with rotary encoder 22 and linear encoder 24 as well as components of probe 10.

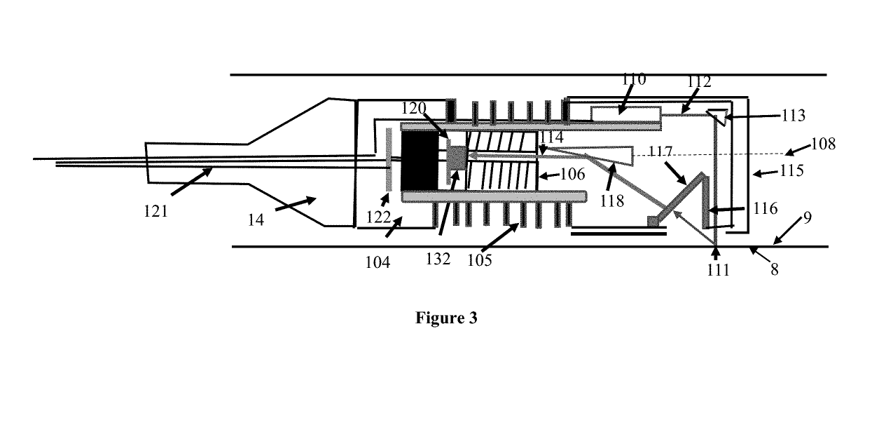

Turning to FIG. 3, further details of probe 10 are shown. Probe 10 has body 104 which is partially disposed within bore 8 when measurements are being taken. Probe body 104 is attached to probe shaft 14 by screws or other means (not shown). Body 104 is preferably cylindrically shaped for improved balance during rotation and reduction of air turbulence. However, for cooling purposes body 104 may have circular fins 105 around the outer circumference of the probe to help dissipate heat. The thermoelectric cooler also may have cooling fins 106 that are in direct contact with the metallic probe body so that thermal energy could be transferred to the outside of the probe.

The interior of body portion 104 is preferably shaped for easy insertion and removal of optic and electronic components with grooves and slots for such components (not shown) and may be covered by a removable outer envelope 115. However, other shapes, diameters and lengths may be employed without departing from the scope of the present disclosure.

Probe shaft 14 has a clear through hole through its center. In addition to enabling power to be transmitted into the probe and data to be transmitted out of the probe, the hole in the shaft and rotor could also enable clean, low pressure compressed air to flow into and through the probe body to create a positive pressure shielding the optics and other internal components from the outside environment.

Laser 110 is mounted in a mounting groove in body portion 104 and is aligned to emit laser beam 112 parallel to axis 108. Set screws (not shown) can be used to adjust the laser beam alignment and hold laser 110 in position in probe body 104. A reflective optical component 113 is used to direct laser beam 112 perpendicularly onto surface 9 of bore 8. Reflective optical component 113 could be a flat mirror, rod mirror, right angle mirror or a pentaprism.

Focusing optical components such as lenses associated with laser 110 could be adjusted to focus laser beam 112 into spot 111 on surface 9 of bore 8. If laser 110 has a fixed focal length, the location 111 of best focus of beam 112 can be adjusted to focus beam 112 onto surface 9 by moving laser 110 in its groove in body 104 until the smallest focal spot is produced on surface 9.

The light from incident beam 112 is reflected, scattered and absorbed by surface 9 in the focal region 111 of beam 112. The absorbed portion of beam 112 is converted to infrared radiation. Small specks of metal on or attached to surface 9 may instantaneously be heated and raised in temperature relative to the background metal surface 9. These specks can instantaneously radiate an increased amount of infrared radiation relative to the background metal surface that could be detected as an increased signal by infrared radiation detector 132 as rotating probe 10 scans the surface 9 of bore 8. The infrared radiation from spot 111, transmitted through wavelength filter 117, is reflected by mirror 118 as infrared beam 114 in the direction of detector 132.

The intensity of infrared radiation in beam 114 on the surface of the detector may be increased using an imaging lens (not shown) transparent to the infrared wavelengths to which detector 132 is sensitive to collect more infrared radiation from a larger solid angle and image it onto a small spot on detector 132.

Laser and visible background light, as well as infrared radiation from sources other than focused laser spot 111 is prevented from reaching detector 132. This can be done by using infrared laser wavelength filter 117 and its aperture 116 to block sources of radiation not coming from focused laser spot 111. Filters to reject unwanted light include notch filters to reject light at the laser wavelength and lowpass filters to permit only light with wavelengths above a specified value to be transmitted. Therefore, detector 132 detects primarily infrared radiation from the surface area illuminated by spot 111.

The output of detector 132 is transmitted to preamplifier electronic circuit 120, which could be an integral part of detector 132. The signal from electronic circuit 120 is converted from a current to a voltage signal and amplified by electronic circuit 122 before being transmitted along cables 121 to slip ring 16, which transmits the signal to data acquisition system 26. Cables 121 could also be used to transmit power into the probe, for example to provide power to the laser in the probe. Other means of transmitting power into and signals out of probe 10 could be used instead of electronics circuit 122, cables 121 and slip ring 16 without departing from the scope of the present disclosure.

In FIG. 3 laser 110 emits beam 112 of laser light that is directed by reflector 113 onto the surface 9 of cylinder bore 8 producing focused laser spot 111 on surface 9. The laser module 110 either contains optics (not shown) that focus beam 112 into spot 111 or focusing optics (not shown) could be placed in front of laser 110 to focus laser beam 112 into spot 111 on surface 9. Incident laser beam 112 in the focal region 111 is either scattered from surface 9 of cylinder bore 8 or absorbed by the material on the surface. If there are specks of material clinging to surface 9, these will be heated more than the rest of surface 9 and could be detected by infrared sensitive detector 132. Detector 132 could be directly facing spot 111 on surface 9 of cylinder bore 8 or infrared light 114 radiating from spot 111 could be reflected by infrared reflecting mirror 118 onto detector 132.

If the IR light is reflected from a mirror before entering the detector, the mirror would be coated to provide the highest reflectivity at the desired IR wavelength.

The detector should be made of a material that is sensitive to infrared radiation and has a fast time response. InGaAs may be an appropriate detector material for this application. Detectors utilizing this material for detecting infrared radiation are commercially available.

The signal from detector 132 is amplified by detector electronics 120 and 122 in probe body 104, and the amplified signal is sent through slip ring 16 to data acquisition unit 26. The data can be processed by computer 28 to produce an image of surface 9 in infrared light, which can be displayed on monitor 30, to indicate where surface roughness is highest. It may then be possible to reduce the roughness of these areas using laser annealing, which is similar to the laser probe measurement of surface roughness itself but optimized to heat tiny specs of metal until they vaporize, melt or otherwise wilt to reduce friction produced by these features.

Mirror 118 is designed to reflect infrared radiation over the wavelengths to which infrared detector 132 is sensitive. Interior surfaces of the probe can also be coated black to absorb visible and laser radiation and prevent it from reaching the entrance of detector 132.

Unlike most other inspection techniques that can only detect defects in a component, this system could be modified to actually reduce surface roughness caused by asperities and the frictional losses caused by this type of surface roughness. This could be done simply by raising the intensity of the focused laser beam on the surface to the point where small specks of metal are melted or vaporized. This annealing process will smooth the surface, reducing surface roughness and frictional forces. It may not be necessary to map the surface during annealing, but inspection before and after annealing should reveal a reduction in the number or intensity of heat sources on the surface of the cylinder.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A non-contact optical probe for inspecting the surface of a workpiece comprising:
a laser source that emits an incident beam of light;
an optical system that focuses the optical beam and directs the focused incident beam onto the surface being inspected;
a mechanism for scanning the focused beam across the surface being inspected by moving the focal point of the beam relative to the surface;
an encoder system that tracks the location of the focused beam on the surface as a function of position; and
a wavelength filter that prevents scattered and reflected laser radiation and ambient visible light from reaching an infrared detector inside the probe,
wherein the probe prevents infrared radiation from locations other than the spot illuminated by the focused laser beam from reaching the detector.

2. The detector of claim 1 wherein the laser beam is incident perpendicular to the surface of the workpiece and the infrared radiation from the focused spot is detected at an angle relative to the workpiece surface, the aperture permitting radiation to enter the probe to block infrared radiation not coming directly from the location of the focused laser spot during the scan.

3. The probe of claim 2 wherein the infrared radiation entering the probe through the wavelength filter is reflected from a mirror inside the probe with a coating designed to maximize IR reflectivity, the mirror between the wavelength filter and the detector being aligned so that the center of the transmitted beam is reflected parallel to the probe axis.

4. The probe of claim 2 wherein the mechanism for scanning the laser beam across the surface being inspected is a spindle together with a linear motion stage moving the scanning beam axially across the surface.

5. The probe of claim 4 wherein the infrared detector detects rapid variations in infrared radiation from the surface being inspected as it is scanned by the incident laser beam.

6. The probe of claim 5 wherein the detector signal is processed by a preamplifier circuit integrated into the detector.

7. The probe of claim 5 wherein the detector cavity is artificially cooled to maximize the sensitivity of the detector to IR radiation.

8. The detector of claim 7 wherein a thermoelectric cooling unit cools the detector.

9. The detector of claim 7 wherein a mechanism for keeping the detector cool is a flow of cold dry gas such as nitrogen.

10. The probe of claim 1 wherein the surface being inspected is the surface of a cylinder.

11. The probe of claim 1 further comprising a data acquisition system that records the infrared radiation signal as a function of position on the surface of the workpiece as the workpiece is being scanned.

12. The probe of claim 1 further comprising a processing unit implemented with an algorithm that maps the variation in infrared radiation as a function of position on the surface of the workpiece to identify changes in the amount of infrared radiation emitted by the surface as the scanning laser beam passes over it.
